(19) United States
(12) Patent Application Publication
(10) Pub. No.: US 2011/0037636 A1
(43) Pub. Date: Feb. 17, 2011

(54) SYSTEM AND METHOD FOR VERIFYING PARAMETERS IN AN AUDIOVISUAL ENVIRONMENT

(75) Inventor: James M. Alexander, San Jose, CA (US)

Correspondence Address: Patent Capital Group - Cisco, 6119 McCommas, Dallas, TX, 75214, US

(73) Assignee: Cisco Technology, Inc.

(21) Appl. No.: 12/539,461

(22) Filed: Aug. 11, 2009

(51) Int. Cl. G08C 19/12

(52) U.S. Cl. 341/176

(57) ABSTRACT

A method is provided in one example embodiment and includes communicating a code to initiate cycling through a plurality of potential audiovisual inputs. The method includes receiving image data that is rendered on a display, the image data being based on a first one of the audiovisual inputs. The method also includes comparing the image data of the first one of the audiovisual inputs to a stored test pattern image associated with a selected audiovisual application to verify if the image data matches the stored test pattern for the selected audiovisual application. In more specific embodiments, the cycling through of the plurality of potential audiovisual inputs is terminated if the image data matches the stored test pattern for the selected audiovisual application. The code represents one or more infrared audiovisual commands being repeatedly sent to the display. The commands are sent until the stored test pattern image is detected on the display.

### TECHNICAL FIELD

This disclosure relates in general to the field of audiovisual systems and, more particularly, to verifying parameters in an audiovisual environment.

### BACKGROUND

Audiovisual systems have become increasingly important in today's society. In certain architectures, universal remote controls have been developed to control or to adjust electronic devices. The remote controls can change various parameters in providing compatible settings amongst devices. In some cases, the remote control can turn on devices and, subsequently, switch input sources to find a correct video input to display. Some issues have arisen in these scenarios because of a lack of feedback mechanisms, which could assist in these processes. Furthermore, many of the remote controls are difficult to manipulate, where end users are often confused as to what is being asked of them.

### BRIEF DESCRIPTION OF THE DRAWINGS

To provide a more complete understanding of the present disclosure and features and advantages thereof, reference is made to the following description, taken in conjunction with the accompanying figures, where like reference numerals represent like parts, in which:

FIG. 1 is a simplified block diagram of a system for adjusting and verifying parameters in an audiovisual (AV) system in accordance with one example embodiment;

FIG. 2 is a simplified schematic diagram illustrating possible components of a remote control in accordance with one example embodiment;

FIG. 3 is a simplified schematic diagram of a top view of the remote control in accordance with one example embodiment;

FIG. 4 is a simplified schematic of an example image in accordance with one example embodiment; and

FIG. 5 is a simplified flowchart illustrating a series of example steps associated with the system.

### DETAILED DESCRIPTION OF EXAMPLE EMBODIMENTS

### Overview

A method is provided in one example embodiment and includes communicating a code to initiate cycling through a plurality of potential audiovisual inputs. The method includes receiving image data that is rendered on a display, the image data being based on a first one of the audiovisual inputs. The method also includes comparing the image data of the first one of the audiovisual inputs to a stored test pattern image associated with a selected audiovisual application to verify if the image data matches the stored test pattern for the selected audiovisual application. In more specific embodiments, the cycling through of the plurality of potential audiovisual inputs is terminated if the image data matches the stored test pattern for the selected audiovisual application. The code represents one or more infrared audiovisual commands being repeatedly sent to the display. The commands are sent until the stored test pattern image is detected on the display.

### EXAMPLE EMBODIMENTS

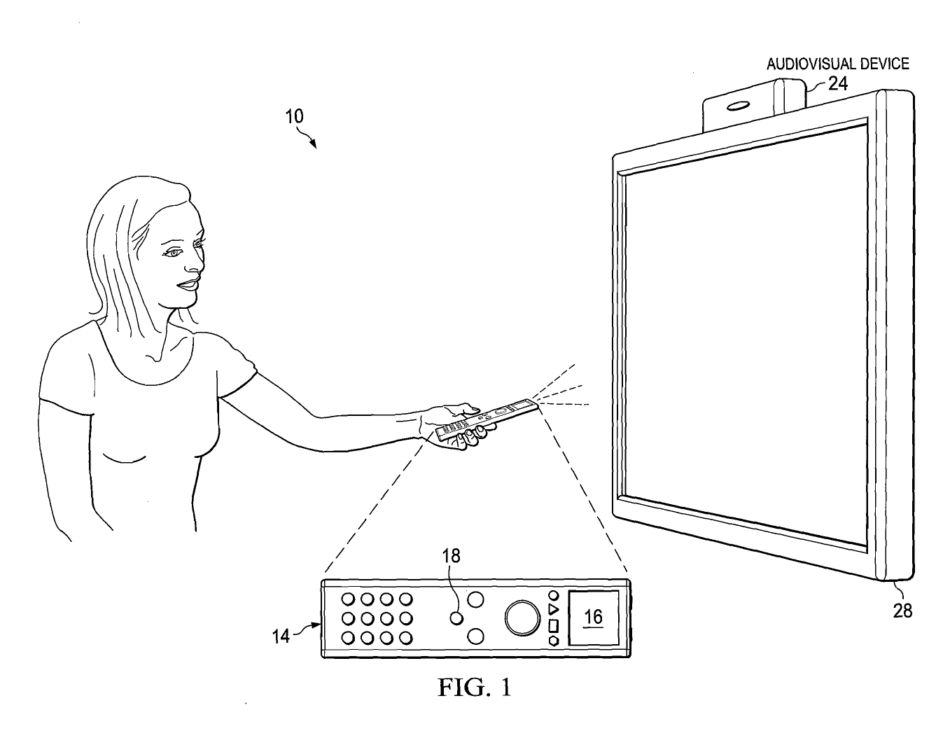

Turning to FIG. 1 is a simplified block diagram of a system 10 for adjusting and verifying parameters in an audiovisual (AV) system in accordance with one example embodiment. System 10 may include a remote control 14, which may include a camera 16 and a dedicated button 18. System 10 also includes an audiovisual device 24, which is configured to interface with a display 28. Both display 28 and audiovisual device 24 are capable of receiving and interpreting various codes being sent by remote control 14. Alternatively, audiovisual device 24 may be provided within display 28, or suitably embedded therein, such that it can receive signals from remote control 14 and render data to display 28 (e.g., via a video input such that display 28 renders images and/or provides audio through one or more speakers).

Before detailing the infrastructure of FIG. 1, some contextual information is provided. Such information is offered earnestly and for teaching purposes only and, therefore, should not be construed in any way that would limit broad applications for the present disclosure. A problem exists in complex AV systems and, to better accommodate these architectures, a host of universal remote control solutions have been provided to simplify AV operations. The objective in many of these environments is simply to perform some activity, such as watching a DVD movie, playing a videogame, or toggling between video inputs. Certain macros (which are sequences of instructions for performing some task) can be employed to address some of these issues. The macros can be sent using infrared, and they can dictate how corresponding devices are to behave. There are several problems associated with such a solution. For example, a macro does not understand the current state of the electronic device. For instance, a macro would not understand if the AV system were currently ON or OFF. Additionally, there is an open loop problem in these environments, meaning: a person (such as the end user of FIG. 1) does not know if the commands being sent will perform the requested actions. In essence, there is no feedback mechanism present to ensure that an activity has been completed.

A second layer associated with this dilemma deals with a particular end user group who encounters these technical difficulties. One group that is technologically savvy may simply cycle through various inputs (and waste time) in arriving at the appropriate AV source for the particular application sought to be used. For a different group of end users who are not technologically inclined, the AV input selection issue presents an insurmountable problem. Note that the evolution of AV systems into more sophisticated architectures has made this difficulty more prominent. Selecting between various AV sources is incomprehensible to many end users, who simply do not understand what is being asked of them. In many instances, the end user is relegated the task of turning on multiple devices, configuring each device to be on the proper channel, and then coordinating between devices in order to render the appropriate images on display 28.

Example embodiments presented herein can potentially address these issues in several ways. First, remote control 14 can employ the use of camera 16, which gathers information about what an end user would see on display 28. The end user is no longer burdened with trying to identify if the wrong input has been configured and, subsequently, correct the problem himself. Essentially, the system has substitutes for troubleshooting, which would otherwise require the involvement of the end user. In one example implementation, a universal remote control is fitted with an inexpensive camera, which can automate television adjustments to control a display, which may receive input from a selected audiovisual source. Such an architecture would stand in contrast to other remote controls that are incapable of automatically verifying that a requested change in AV mode has, in fact, been completed.

Secondly, the architecture can connect an infrared control decision tree to an image classifier in a feedback loop in order to automate a correct configuration of an audiovisual (or audio video) equipment stack. The intelligent stack would not be the only use of camera 16. For example, the camera could have a possible secondary use as part of a data input or pointing device. Furthermore, remote control 14 can be used for “auto” remote code programming. For example, remote control 14 can cycle through codes and recognize which code affected the television (e.g., turned it off). Note that before turning to some of the additional operations of this architecture and associated examples, a brief discussion is provided about the infrastructure of FIG. 1.

Remote control 14 is an electronic device used for the remote operation of a machine. As used herein in this Specification, the term ‘remote control’ is meant to encompass any type of electronic controller, clicker, flipper, changer, or any other suitable device, appliance, component, element, or object operable to exchange, transmit, or process information in a video environment. This is inclusive of personal computer (PC) applications in which a computer is actively involved in changing one or more parameters associated with a given data stream. In operation, remote control 14 issues commands from a distance to displays (and other electronics). Remote control 14 can include an array of buttons for adjusting various settings through various pathways (e.g. infrared (IR) signals, radio signals, Bluetooth, 802.11, etc.).

As illustrated in FIG. 1, display 28 offers a screen at which video data can be rendered for the end user. Note that as used herein in this Specification, the term ‘display’ is meant to connote any element that is capable of rendering an image and/or delivering sound for an end user. This would necessarily be inclusive of any panel, plasma element, television, monitor, computer interface, screen, or any other suitable element that is capable of delivering such information. Note also that the term ‘audiovisual’ is meant to connote any type of audio or video (or audio-video) data applications (provided in any protocol or format) that could operate in conjunction with remote control 14.

Audiovisual device 24 could be a set top box, a digital video recorder (DVR), a videogame console, a videocassette recorder (VCR), a digital video disc (DVD) player, a digital video recorder (DVR), a proprietary box (such as those provided in hotel environments), a TelePresence device, an AV switchbox, an AV receiver, or any other suitable device or element that can receive and process information being sent by remote control 14 and/or display 28. Each audiovisual device 24 can be associated with an audiovisual application (e.g., playing a DVD movie, playing a videogame, conducting a TelePresence session, etc.). Similarly, each audiovisual device 24 can be associated with a specific audiovisual input. Alternatively, a single audiovisual device 24 can include multiple audiovisual applications in a single set-top box and, similarly, account for multiple audiovisual inputs.

Audiovisual device 24 may interface with display 28 through a wireless connection, or via one or more cables or wires that allow for the propagation of signals between these two elements. Audiovisual device 24 and display 28 can receive signals from remote control 14 and the signals may leverage infrared, Bluetooth, WiFi, electromagnetic waves generally, or any other suitable transmission protocol for communicating data from one element to another. Virtually any control path can be leveraged in order to deliver information between remote control 14 and display 28. Transmissions between these two devices are bidirectional in certain embodiments such that the devices can interact with each other. This would allow the devices to acknowledge transmissions from each other and offer feedback where appropriate.

Remote control 14 may be provided within the physical box that is sold to a buyer of an associated audiovisual device 24. An appropriate test pattern may be programmed in remote control 14 in such an instance in order to carry out the operations outlined herein. Alternatively, remote control 14 can be provided separately, such that it can operate in conjunction with various different types of devices. In other scenarios, remote control 14 may be sold in conjunction with a dedicated AV switchbox or AV receiver, which could be configured with multiple test patterns corresponding to each of its possible inputs. Such a switchbox could provide feedback to remote control 14 regarding which input it has determined is being displayed.

In one example implementation, remote control 14 is preprogrammed with a multitude of test patterns, which can be used to verify the appropriate AV source is being used. In other scenarios, an application program interface (API) could be provided to third parties in order to integrate remote control 14 into their system's operations. Other example implementations include downloading new or different test patterns in order to perform the verification activities discussed herein. Test patterns could simply be registered at various locations, or on websites, such that remote control 14 could receive systematic updates about new test patterns applicable to systems being used by their respective end users. Further, some of this information could be standardized such that patterns on display 28 could be provided at specific areas (e.g., via a small block in the upper left-hand corner of display 28, or in the center of display 28, etc.).

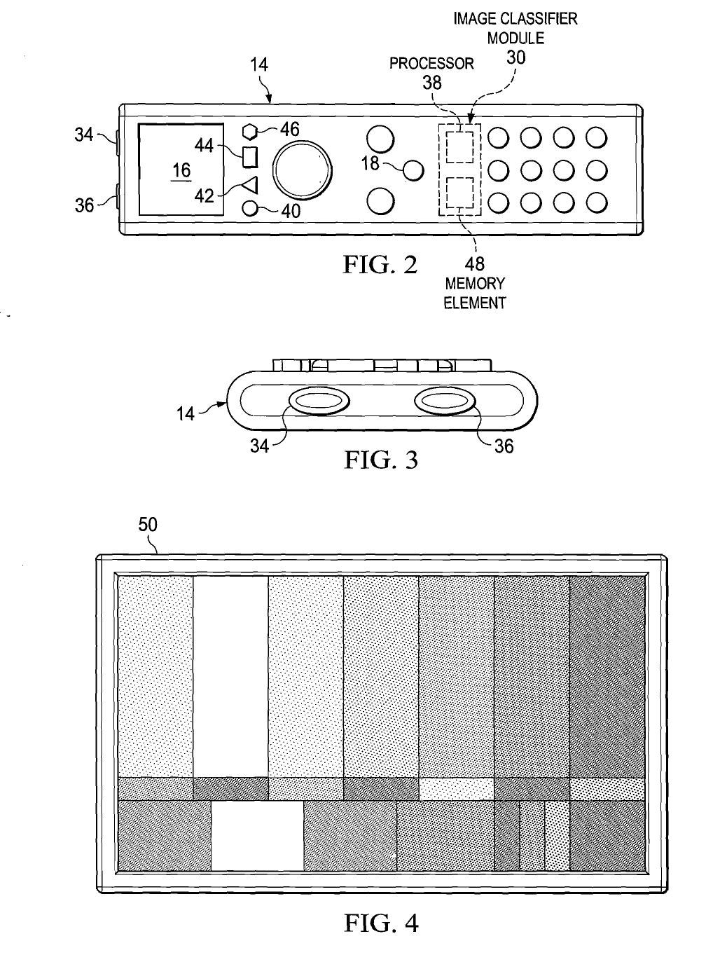

FIG. 2 is a simplified schematic diagram of remote control 14, which further details potential features to be included therein. In one example implementation, remote control 14 includes an image classifier module 30. Image classifier module 30 may include (and/or interface with) a processor 38 and a memory element 48. Image classifier module 30 can include an automation algorithm that includes two components in one example implementation. One component identifies the theorized state of audiovisual device 24 based on data being imaged by camera 16. A second component allows new commands to be sent by remote control 14 in order to change the state of audiovisual device 24.

Remote control 14 also includes a camera optics element 34 and an infrared emitter 36 (and this is further shown in FIG. 3, which offers a top view of remote control 14). In one example, camera optics element 34 includes a fisheye lens in order to improve the field of view (offering a wide view) and reliability of the image detection. In using a wide view type of lens, inaccuracies in pointing remote control 14 haphazardly are accommodated. Alternatively, camera optics element 34 may include any suitable lens to be used in detecting a testing pattern (i.e., an image). In one example implementation, camera optics element 34 and infrared emitter 36 are provided in a parallel configuration in order to further engender feedback being provided by display 28. For example, feedback from audiovisual device 24 can be provided based on IR codes being sent by infrared emitter 36. Thus, the feedback being received by camera optics element 34 is corresponding to an appropriate aiming of infrared emitter 36 to deliver the appropriate IR codes.

In one example, remote control 14 further includes a number of dedicated buttons 40, 42, 44, and 46, which can expedite a series of activities associated with displaying information on display 28. These buttons may be provided in conjunction with dedicated button 18, or be provided as an alternative to button 18 in that this series of buttons can offer application specific operations, which can be performed for each associated technology.

For example, button 40 may be configured to perform a series of tasks associated with playing a DVD movie. Button 40 may simply be labeled “DVD Play”, where an end user could press button 40 to initiate a series of instructions associated with delivering the end user to the appropriate application for playing DVD movies. The user in this instance was initially watching television and by pressing button 40, the DVD player could be powered on, and the proper video source could be selected for rendering the appropriate AV information on display 28. There could be a subsequent step involved in this set of instructions, in which the movie could be played from its beginning, or at a location last remembered by the DVD player. If the particular end user would like to return to watching television, remote control 14 can include a dedicated button (e.g., “Watch TV) that would deliver the end user back to a television-watching mode. In other examples, a simple dedicated button (e.g., labeled “EXIT”) could be used as a default for returning to a given mode (e.g., watching television could be the default when the EXIT button is pressed).

Essentially, each of the buttons (similar to dedicated button 18) has the requisite intelligence behind them to launch an AV selection process, as discussed herein. In order to improve the ease of use, in one implementation, each of buttons 40, 42, 44, and 46 are uniquely shaped (or provided with different textures or colors) to help automate (and/or identify) its intended operation for the end user.

In certain examples, each of these dedicated buttons can be used to trigger an operation that cycles through a loop to find the correct video source, and then subsequently deliver the end user to the opening menu screen of the associated program. From this point, the end user can simply navigate through that corresponding system (e.g., select an appropriate chapter from a movie, select a videogame, select a feed from a remote TelePresence location, etc.). Thus, each of dedicated buttons 40, 42, 44, and 46 can have multiple activities associated with pressing each of them, namely: powering on one or more implicated devices, cycling through various potential AV inputs, identifying a correct input feed based on image recognition, and delivering the end user to a home screen, a menu, or some other desired location within the application.

Button 42 may be configured in a similar fashion such that a videogame console could be triggered upon pressing button 42. Again, the possible audiovisual inputs would be cycled through to find the correct video source such that a subsequent video game could be played. Buttons 44 and 46 could involve different applications, where a single press of these buttons could launch the application, as described above.

Remote control 14 may include any suitable hardware, software, components, modules, interfaces, or objects that facilitate the operations thereof. This may be inclusive of appropriate algorithms and communication protocols that allow for the effective image recognition and input verification, as discussed herein. In one example, some of these operations can be performed by image classifier module 30. As depicted in FIG. 2, remote control 14 can be equipped with appropriate software to execute the described verification and image recognition operations in an example embodiment of the present disclosure. Memory elements and processors (which facilitate these outlined operations) may be included in remote control 14 or be provided externally, or consolidated in any suitable fashion. The processors can readily execute code (software) for effectuating the activities described.

Remote control 14 can include memory element 48 for storing information to be used in achieving the image recognition and/or verification operations, as outlined herein. Additionally, remote control 14 may include processor 38 that can execute software or an algorithm to perform the image recognition and verification activities as discussed in this Specification. These devices may further keep information in any suitable memory element [random access memory (RAM), ROM, EPROM, EEPROM, ASIC, etc.], software, hardware, or in any other suitable component, device, element, or object where appropriate and based on particular needs. Any of the memory items discussed herein should be construed as being encompassed within the broad term ‘memory element.’ The image recognition could be provided in any database, register, control list, or storage structure: all of which can be referenced at any suitable timeframe. Any such storage options may be included within the broad term ‘memory element’ as used herein in this Specification. Similarly, any of the potential processing elements, modules, and machines described in this Specification should be construed as being encompassed within the broad term ‘processor.’

Note that in certain example implementations, image recognition and verification functions outlined herein may be implemented by logic encoded in one or more tangible media (e.g., embedded logic provided in an application specific integrated circuit [ASIC], digital signal processor [DSP] instructions, software [potentially inclusive of object code and source code] to be executed by a processor, or other similar machine, etc.). In some of these instances, memory elements [as shown in FIG. 2] can store data used for the operations described herein. This includes the memory elements being able to store software, logic, code, or processor instructions that are executed to carry out the activities described in this Specification. A processor can execute any type of instructions associated with the data to achieve the operations detailed herein in this Specification. In one example, the processors [as shown in FIG. 2] could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array [FPGA], an erasable programmable read only memory (EPROM), an electrically erasable programmable ROM (EEPROM)) or an ASIC that includes digital logic, software, code, electronic instructions, or any suitable combination thereof.

FIG. 4 is a simplified diagram depicting an image 50 from camera 16 of remote control 14. The image from camera 16 can be fed into a pattern recognition algorithm, which may be part of image classifier module 30. The detection of the presence or absence of a target test pattern can indicate to remote control 14 whether the desired state has been achieved in the end user's AV system. One or more test patterns may be stored within memory element 48 such that it can be accessed in order to find matches between a given pattern and image data being received by camera 16. For example, when remote control 14 is directed toward display 28, camera 16 may interface with camera optics element 34 to receive information from display 28. This information is matched against one or more patterns stored in memory element 48 (or stored in any other suitable location) in order to verify that the appropriate AV source is being rendered (i.e., delivered to) display 28.

A simple image processor (e.g., resident in image classifier module 30) can perform the requisite image recognition tasks when display 28 is in the field of view of camera 16. Camera 16 can operate in conjunction with image classifier module 30 to verify that commands or signals sent to a display had actually been received and processed. Camera 16 could further be used to determine if scan rates are compatible between source and monitor. In one example implementation, audiovisual device 24 is a consumer video device that is sold with remote control 14, which may be preprogrammed with predefined images and the correct infrared codes to adjust the television. In this particular consumer device example, remote control 14 includes an inexpensive, low-fidelity digital camera to be used in the operations discussed herein.

Once suitably powered (e.g., with batteries or some other power source), remote control 14 can begin sending control commands to a television in a repeating loop for AV inputs. At the same time, a given video device connected to the television can display a preselected high contrast pattern such as alternating black-and-white bars, as shown in FIG. 4. Camera 16 is able to recognize such a pattern with simple, fast image-processing techniques (e.g., pixel value histograms of sub-images, other suitable pattern matching technologies, etc.). When the displayed image is recognized as matching a stored test pattern for the associated (selected) audiovisual application, the adjustment loop is terminated. The correct audiovisual application input has been verified and the end user can continue in a normal fashion with the application.

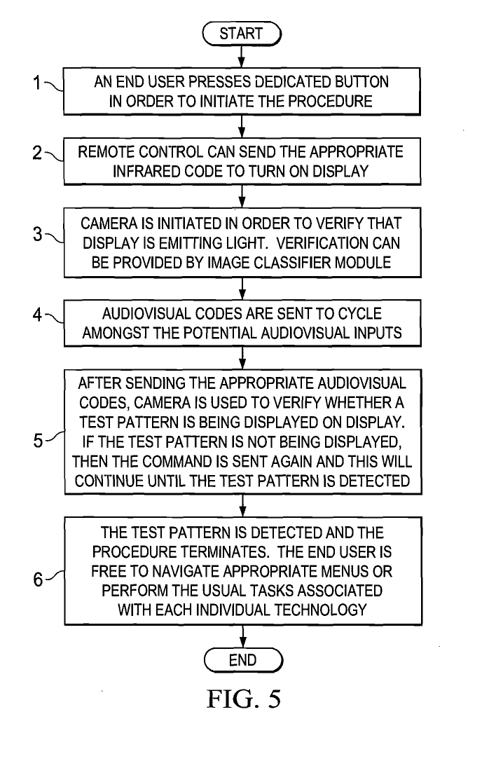

FIG. 5 is a simplified flowchart illustrating an example set of operations that may be performed by remote control 14. This example considers an end user seeking to control audiovisual device 24, which represents one of a potential multitude of different inputs being fed to display 28. The objective in this simple procedure is to turn on display 28 and to find the right AV source to render onto display 28. At step one, an end user simply presses dedicated button 18 in order to initiate the procedure. At step two, remote control 14 can send the appropriate infrared code to turn on display 28. At step three, camera 16 is initiated in order to verify that display 28 is emitting light. This verification can be part of the capabilities provided by image classifier module 30.

At step four, AV codes are sent to remote control 14 to cycle amongst the potential AV inputs. After sending the appropriate AV codes, camera 16 is used to verify whether a test pattern is being displayed on display 28 at step five. If the test pattern is not being displayed, then the AV codes (e.g., additional commands) are sent again and this will continue until the test pattern is detected. Note that some technologies can include a command for cycling amongst the various inputs. In such a case, image classifier module 30 may leverage this looping protocol in identifying the appropriate input being sought by the end user.

At step six, the test pattern is detected in this example by matching what is displayed as image data with what is stored as a test pattern image associated with a particular audiovisual application. Once these two items are properly matched, the procedure terminates. From this point, the end user is free to navigate appropriate menus or simply perform the usual tasks associated with each individual technology (for example, play a DVD movie, initiate a videogame, interface with TelePresence end users remotely, etc.). Note that one inherent advantage in such a protocol is that remote control 14 is designed to systematically send the input sequence until it sees confirmation of the testing pattern on display 28. Such activities would typically be performed repeatedly by an end user, and this needlessly consumes time.

Note that with the example provided above, as well as numerous other examples provided herein, interaction may be described in terms of two or three elements. However, this has been done for purposes of clarity and example only. In certain cases, it may be easier to describe one or more of the functionalities of a given set of flows by only referencing a limited number of elements. It should be appreciated that system 10 (and its teachings) are readily scalable and can accommodate a large number of electronic devices, as well as more complicated/sophisticated arrangements and configurations. Accordingly, the examples provided should not limit the scope or inhibit the broad teachings of system 10 as potentially applied to a myriad of other architectures.

It is also important to note that the steps discussed with reference to FIGS. 1-5 illustrate only some of the possible scenarios that may be executed by, or within, system 10. Some of these steps may be deleted or removed where appropriate, or these steps may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by system 10 in that any suitable arrangements, chronologies, configurations, and timing mechanisms may be provided without departing from the teachings of the present disclosure.

Although the present disclosure has been described in detail with reference to particular embodiments, it should be understood that various other changes, substitutions, and alterations may be made hereto without departing from the spirit and scope of the present disclosure. For example, although the present disclosure has been described as operating in audiovisual environments or arrangements, the present disclosure may be used in any communications environment that could benefit from such technology. Virtually any configuration that seeks to intelligently cycle through input sources could enjoy the benefits of the present disclosure.

Moreover, although some of the previous examples have involved specific architectures related to consumer devices, the present disclosure is readily applicable to other video applications, such as the TelePresence platform. For example, the consumer (or business) TelePresence product could use this concept to automate turning on a display (e.g., a television) and switching to the right input when an incoming call is accepted, when an outgoing call is placed, when the user otherwise has signaled a desire to interact with the system, etc. For example, an end user may wish to configure the TelePresence AV system when prompted by an unscheduled external event (e.g., an incoming phone call). In operation, the end user can stand in front of display 28 and use remote control 14 when assenting to a full video TelePresence call. In an architecture where this is not the expected use case, camera 16 could be located elsewhere, for example in the charging cradle for a handset. The system could use an in-view placement of the cradle for the feature to be better supported. This could make the TelePresence technology even easier to use and manage.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112a as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method, comprising:
communicating a code to initiate cycling through a plurality of potential audiovisual inputs;
receiving image data that is rendered on a display, the image data being based on a first one of the audiovisual inputs; and
comparing the image data of the first one of the audiovisual inputs to a stored test pattern image associated with a selected audiovisual application to verify if the image data matches the stored test pattern for the selected audiovisual application.

2. The method of claim 1, wherein the cycling through of the plurality of potential audiovisual inputs is terminated if the image data matches the stored test pattern for the selected audiovisual application.

3. The method of claim 1, further comprising:
communicating an initial code to turn on the display; and
verifying that the display is emitting light.

4. The method of claim 1, wherein the code represents one or more infrared audiovisual commands being repeatedly sent to the display.

5. The method of claim 4, wherein the commands are sent until the stored test pattern image is detected on the display.

6. The method of claim 1, wherein the selected audiovisual application is part of a group of audiovisual applications, the group consisting of:
a) a videogame application;
b) a videocassette recorder (VCR) application;
c) a digital video disc (DVD) player application;
d) a digital video recorder (DVR) application;
e) an audiovisual switchbox application; and
f) an audiovisual receiver application.

7. The method of claim 1, wherein the stored test pattern image is stored in a memory element that includes a plurality of test pattern images corresponding to particular audiovisual applications.

8. Logic encoded in one or more tangible media that includes code for execution and when executed by a processor operable to perform operations comprising:
communicating a code to initiate cycling through a plurality of potential audiovisual inputs;
receiving image data that is rendered on a display, the image data being based on a first one of the audiovisual inputs; and
comparing the image data of the first one of the audiovisual inputs to a stored test pattern image associated with a selected audiovisual application to verify if the image data matches the stored test pattern for the selected audiovisual application.

9. The logic of claim 8, wherein the cycling through of the plurality of potential audiovisual inputs is terminated if the image data matches the stored test pattern for the selected audiovisual application.

10. The logic of claim 8, wherein the logic is further operable to perform operations comprising:
communicating an initial code to turn on the display; and
verifying that the display is emitting light.

11. The logic of claim 8, wherein the code represents one or more infrared audiovisual commands being repeatedly sent to the display.

12. The logic of claim 11, wherein the commands are sent until the stored test pattern image is detected on the display.

13. The logic of claim 8, wherein the stored test pattern image is stored in a memory element that includes a plurality of images corresponding to particular audiovisual applications.

14. An apparatus, comprising:
a memory element configured to store data,
a processor operable to execute instructions associated with the data, and
an image classifier module configured to interact with the processor in order to:
communicate a code to initiate cycling through a plurality of potential audiovisual inputs;
receive image data that is rendered on a display, the image data being based on a first one of the audiovisual inputs; and
compare the image data of the first one of the audiovisual inputs to a stored test pattern image associated with a selected audiovisual application to verify if the image data matches the stored test pattern for the selected audiovisual application.

15. The apparatus of claim 14, wherein the cycling through of the plurality of potential audiovisual inputs is terminated if the image data matches the stored test pattern for the selected audiovisual application.

16. The apparatus of claim 14, wherein the code represents one or more infrared audiovisual commands being repeatedly sent to the display.

17. The apparatus of claim 16, wherein the commands are sent until the stored test pattern image is detected on the display.

18. The apparatus of claim 14, further comprising:
an infrared emitter configured to interface with the image classifier module and to communicate the code to the display.

19. The apparatus of claim 14, wherein the stored test pattern image is stored in a memory element that includes a plurality of test pattern images corresponding to particular audiovisual applications.

20. The apparatus of claim 14, further comprising:
a lens optics element configured to interface with the image classifier module in order to deliver the image data to the image classifier module.
